(19) United States
(12) Patent Application Publication
(10) Pub. No.: US 2023/0229021 A1
(43) Pub. Date: Jul. 20, 2023

(54) PERIPHERAL QUADRANT DESIGN CONTACT LENS

(71) Applicant: Hsiao-Ching TUNG, South Pasadena, CA (US)

(72) Inventor: Hsiao-Ching TUNG, South Pasadena, CA (US)

(21) Appl. No.: 18/009,704

(22) PCT Filed: Jun. 10, 2021
(86) PCT No.: PCT/US2021/036883

§ 371 Date: Dec. 9, 2022

Related U.S. Application Data
(60) Provisional application No. 63/037,547, filed on Jun. 10, 2020.

(51) Int. Cl. G02C 7/04

(52) U.S. Cl. CPC G02C 7/047; G02C 2202/24

(57) ABSTRACT

A contact lens, which can be any of a conventional rigid contact lens, an orthokeratology lens, a scleral lens or a soft contact lens, which has one or more peripheral annular zones adjacent to and radially outward from a central optical zone of the contact lens. The peripheral annular zones include an alignment zone for orientation control, upright control or peripheral alignment to improve the molding effect of an orthokeratology lens, a comfort or vision quality of a regular RGP, scleral contact lens or soft contact lens. The sagittal height of the lens in the alignment zone along a sub-axis differs from the sagittal height of the lens along at least one other sub-axis.

### CROSS-REFERENCE TO RELATED APPLICATIONS

This application claims the benefit of priority from U.S. Patent Application No. 63/037,547, filed Jun. 10, 2020. The disclosure of the foregoing application is incorporated herein by reference in its entirety.

### BACKGROUND

Many people experience difficulties with their vision due to a number of possible conditions. The most common vision problem is a condition known as myopia or nearsightedness. Myopia is a common condition where an eye cannot focus on far-away objects because the cornea of the eye is curved too steeply (i.e., where the radius of curvature of the cornea is shorter than normal) to provide adequate focusing at the retina of the eye. Another condition is known as hyperopia or farsightedness. With hyperopia, the eye cannot focus on both far and near objects because the curvature of the cornea of the eye is too flat (i.e., where the radius of curvature of the cornea is longer than normal) to provide adequate focusing at the retina of the eye. Hyperopia is common among young children. Severe hyperopia will induce lazy eye or amblyopia in childhood. Another common problem is astigmatism, where unequal curvature of one or more refractive surfaces of the cornea prevents light rays from focusing clearly at one point on the retina, resulting in blurred vision. Presbyopia is the most common vision problem in adults 40 years and older. It does not matter whether they are emmetropic, myopic or hyperopic in far vision, the middle-aged population over 40 years old will begin to experience difficulty in focusing on close objects due to the loss of flexibility of the eye's crystalline lens. Presbyopia may occur and complicate other refractive problems such as hyperopia, myopia or astigmatism.

A normal cornea is usually parabolic in shape, which is steepest in curvature (i.e., having a shorter radius) at, or nearly at, the central portion of the cornea and becomes progressively flatter in curvature (i.e., having a longer radius) toward the limbus by a certain positive e-value, or so-called “positive shape factor”. An altered cornea is a cornea that is significantly different from the normal parabolic shape, having an abruptly protruded portion or a “negative shape factor” for a human cornea, which may occur naturally, or result from a refractive surgical procedures. The former condition, i.e. “naturally altered,” is best demonstrated by keratoconus, while the latter condition, i.e. due to surgical procedures, is best illustrated by the myopic refractive surgery such as LASIK, PRK and RK.

Notwithstanding the improvements provided by modern spectacles, contact lenses, intraocular lenses, refractive surgery, corneal cross-linking and implantable intracorneal ring segments (e.g., Intac corneal rings) for keratoconus and post refractive surgical failures, there remains a need for designing optical devices, or more specifically, rigid and soft specialty contact lenses, scleral lenses and orthokeratology (“ortho-k”) lenses that may achieve better correction for all of the above conditions.

The parabolic ocular surface of the cornea and its adjacent scleral portion is not always regular or symmetrical in shape. The corneal or scleral irregularity may be caused by corneal trauma, refractive surgery, a corneal transplant, or an ocular disease such as keratoconus or marginal degeneration. Even if the ocular surface is generally normal, the corneal or corneo-scleral contour may be still highly toric or tilted so as to influence lens centration, vision quality and ortho-k molding effect. The former condition, i.e. an “irregular” corneal surface, may need a scleral lens to cover the whole cornea and rest on the scleral portion to form a new regular refractive surface for visual correction in a wide range of difficult conditions. The new refractive surface may need further correction by adding a front toric shape onto a front optical zone to correct internal astigmatism or adding axial thickness to one or more than one quadrants of the lens. Both conditions will need to lock down and stabilize the lens orientation.

In the latter condition i.e. a highly toric/tilted, but generally normal cornea or corneo-scleral surface, there could be requirement to lock down the lens orientation for a variety of reasons, including but not limited to incorporation of a toric power on the front optical zone for a regular RGP or scleral lens to correct residual astigmatism, or for orienting the optical zone 22 and/or centering the lens when placing it on a tilting or highly toric cornea in ortho-k molding.

It is known to orient lenses by methods such as prism ballasting or truncation, by forming a thicker edge in soft or rigid contact lenses for pulling the thicker side with the thicker edge downward to control rotation, which has been broadly used in rigid and soft toric contact lens industry. Prism ballasting works well in daywear contact lenses for orientation control by gravity and does not need to rely on conforming to the corneal shape for orientation. However, prism ballasting may cause significant irritation to eyes and it does not work in a supine position such as that in ortho-k molding, which uses the lenses for sleeping hours. Another approach is to allow the eyelid to grasp the lens for orientation control, which has been widely adopted in soft toric contact lenses by forming one or two thinner or pliable edges for the eyelid, to control lens orientation by holding the thinner lens edge between the eyelids.

Another approach for controlling lens orientation, described in U.S. Pat. No. 7,296,890, is the use of a single component lens having four sets of base curves with 4 corresponding sub-axes to create a back surface that conforms to a measured corneal shape. This approach controls lens orientation by conforming the lens to match the measured corneal surface to allow further designs to be incorporated on front optical zone when the lens needs to be locked down for orientation control. While this approach works for orientation control, it is unsuitable for ortho-k molding, which requires the base curve to be determined for corneal molding, so that it cannot be set to conform to the central corneal shape for orientation control. This “Central Quadrant Design,” which incorporates multiple base curves with sub-axes in the central portion of the contact lens for day wear, may induce unwanted residual astigmatism while wearing the contact lens and may complicate the lens power to be ground on the front optical zone of the lens.

### SUMMARY OF THE INVENTION

The present invention relates to vision science and a methodology for designing devices and contact lenses that are used in fitting contact lenses and ortho-k molding for myopia correction and myopia control, hyperopia, presbyopia, and more particularly in managing corneal astigmatism or altered corneas (such as keratoconus or post refractive surgical failures). The invention can be applied for producing rigid contact lenses, ortho-k lenses, scleral lenses and soft contact lenses in which the back surface of the intermediate and/or peripheral zones of the lens have different sagittal heights in one or more than one sub-axis or quadrant (Peripheral Quadrant design, or P-Qdrt) such that the lens sagittal heights in all sub-axes or quadrants can fit the patient's ocular surface more precisely for less rotation or tilting on the eye 10. The intermediate and peripheral curves of a P-Qdrt toric RGP contact lens can be spherical or aspheric with plural sub-axes, curvatures or eccentricity values, while the base curve, the central curve of the back surface of the contact lens 20, is rotationally symmetrically spherical or aspheric in curvature such that labs can easily add desired toric power and/or lens axial thickness on its front surface with fixed orientation for clear vision and stable astigmatism correction. While the central base curve is made 360 degrees rotationally uniform, this irrelevant to orientation control of the contact lens. More than lens orientation, the P-Qdrt contact lens also helps ortho-k molding, especially for molding toric or inclined corneas, by enabling the alignment zone 26 to have a better water seal to exert a stronger peripheral inward pushing force. The invention also includes a methodology to create the P-Qdrt trial sets of lenses for double checking the corneal sagittal heights, in particular within sub-axes, obtained from the measurement devices, including but not limited to the corneal topography, 3D map or OCT, in lens design.

It is an object of the present invention to provide a methodology for creating rigid contact lenses, ortho-k lenses, scleral lenses or soft contact lenses for a plurality of purposes. The first object of the present invention is orientation control for a contact lens which requires fixing the orientation for incorporation of the cylinder power with an axis on the front optical zone 31, or to provide additional lens axial thickness on one or more fixed quadrants, or for ortho-k reshaping on a toric cornea having internal astigmatism that needs a toric or asymmetric base curve to mold a fixed sub-axis or quadrant for correction of the internal astigmatism. The present invention, referred to as Peripheral Quadrant Design (P-Qdrt), can lock down the lens orientation without affecting the base curve, or the central back curve, of the contact lens 20 to conform the measured cornea for orientation control. The base curve of the central back surface of P-Qdrt ortho-k contact lenses 20 is usually designed with a spherical or aspheric curvature that is 360 degrees rotationally uniform. The optical zone 22 can also be created toric, tilted or quadrant but having the curvature sub-axis not conforming to the measured cornea, of which the base curve can be flatter or steeper than the cornea curvature, and the axis can be opposite to, or oblique to that of the corneal curvatures. The uneven (toric, tilted or quadrant) optical zone 22 so created for ortho-k molding, along with the P-Qdrt alignment zone 26 for orientation control, can be used to mold off the internal or crystalline astigmatism that forms a new corneal toricity different from that of the original cornea. Hence, the present invention enables the control of lens orientation by the P-Qdrt lens' periphery, and frees up the central optical zone 22 and its base curves for a function other than orientation control. The optical zone 22 and its base curve(s) of the present invention can be designed as not conforming to the central cornea shape while still controlling the lens orientation with the peripheral alignment zone 26 for ortho-k molding of corneas having internal astigmatism.

Another object of the present invention, referring to as upright control, is to provide an ortho-k contact lens, regular RGP lens, scleral lens or soft contact lens, having a plurality of sets of sagittal heights with sub-axes, for the optical center to sit upright on a toric or tilted cornea. The optical center has to intersect the corneal apex tangentially for better ortho-k treatment and clearer vision.

It is yet another object of the present invention to provide an ortho-k contact lens, regular RGP lens, or scleral lens having a plurality of sets of sagittal heights with sub-axes to bear on a peripheral portion of the cornea or sclera more intimately, which is called peripheral alignment. The sagittal height of each sub-axis is predetermined by the measured corneal or ocular information and/or trial fitting with a standard lens trial set, of which the specification of the trial lens is predetermined and well known to the eye care practitioner (ECP). The sagittal height difference of the sub-axis for peripheral alignment is figured into the alignment zone(s) 26 of the contact lens 20, adjacent to and radially outward from the central optical zone(s) 22 or intermediate zone 24 of the contact lens 20. A P-Qdrt lens with peripheral alignment does not need to conform the central or peripheral portion of the cornea 12 or ocular surface of the eye 10, while still dramatically improving centration and water sealing by bearing the peripheral portion of the contact lens 20 more intimately on the peripheral portion of the cornea 12. A P-Qdrt lens for peripheral alignment is especially useful in ortho-k molding of a cornea 12 having high toricity, tilting or irregularity for improving peripheral water sealing. The alignment zone 26 so created can exert a more effective inward pushing force on a peripheral portion of the cornea 12 for inward molding. It is also helpful to design P-Qdrt regular RGP or scleral contact lenses for better centration on a highly toric or irregular cornea, by aligning the contact lens more intimately on the irregular cornea or sclera surface. If a ECP routinely checks corneal elevation maps with reliable topography and figure this into a P-Qdrt lens for upright control or peripheral alignment, they may save chair time with less lens exchange and prevent problems.

The objects of the present invention can be achieved by providing a P-Qdrt lens with the presently disclosed methodology to determine a plurality of sets of corneal sagittal heights within sub-axes for the cornea 12 or ocular surface of the eye 10, and implement the sagittal height information into alignment zone 26 for orientation control, upright control or peripheral alignment. A P-Qdrt design can improve the molding effect of an ortho-k lens, or the visual quality of a regular RGP lens, scleral lens or soft contact lens.

### BRIEF DESCRIPTION OF THE DRAWINGS

FIG. 1 is a side schematic outline of a P-Qdrt contact lens according to the present invention in use with a cornea of a patient's eye.

FIG. 2 is a front plan view of an embodiment of the present P-Qdrt contact lens, showing 4 sets of alignment zone sub-axes.

FIG. 3 is a front plan view of another embodiment of the present P-Qdrt contact lens, showing 4 sets of alignment zone sub-axes.

FIGS. 4 and 5 illustrate ocular elevation using the following information for the sagittal height of a corneal front surface (BFS: central corneal radius 7.67 mm; eccentricity value: 0.46):

| | Sub-axis | | | | |
|---|---|---|---|---|---|
| Height (μ) | BFS | 0° | 90° | 180° | 270° |
| Sagittal height (μ) | 2731 | 2494 | 2613 | 2973 | 2851 |
| Elevation vs BFS (μ) | 0 | 237 | 119 | −242 | −120 |

FIG. 4 shows ocular elevation height, referring to the best-fit sphere (BFS) of the cornea along sub-axes 0°-180°, which can be used to derive the sagittal heights and curves of the alignment zones of the present contact lens.

FIG. 5 shows ocular elevation height, referring to the best-fit sphere (BFS) of the cornea along sub-axes 90°-270°, which can be used to derive the sagittal heights and curves of the alignment zones of the contact lens.

FIG. 6 is a side sectional view of a contact lens designed using the ocular elevation heights shown in FIG. 4 along the 0°-180° sub-axes, with a different lens sagittal height at edge.

FIG. 7 is a side sectional view of a contact lens designed using the ocular elevation heights shown in FIG. 5 along the 90°-270° sub-axes with a different lens sagittal height at edge.

FIG. 8 is a process flow chart for the determination of P-Qdrt data for the manufacturing of P-Qdrt contact lenses for fitting or treatment in accordance with present invention.

FIG. 9 is a diagram showing a client-server networked environment where the present invention may be implemented.

The reference numbers in the figures have the following meanings:

| Component | Reference Number |
|---|---|
| Eye | 10 |
| Cornea | 12 |
| Contact lens | 20 |
| Optical zone | 22 |
| Inner additive optical zone | 23 |
| Intermediate zone | 24 |
| Alignment zone | 26 |
| Peripheral zone | 28 |
| Front surface | 25 |
| Back surface | 27 |
| Periphery | 29 |
| Base curve | 30 |
| Front optical zone | 31 |
| Axis | 40 |
| X-axis | 41 |
| Y-axis | 42 |
| Z-axis (optical axis) | 43 |
| Sub-axis | 50 |
| First sub-axis | 51 |
| Second sub-axis | 52 |
| Third sub-axis | 53 |
| Fourth sub-axis | 54 |
| Quadrant | 60 |
| First quadrant | 61 |
| Second quadrant | 62 |
| Third quadrant | 63 |
| Fourth quadrant | 64 |

### DETAILED DESCRIPTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

### Definitions

As used herein, the following terms and variations thereof have the meanings given below, unless a different meaning is clearly intended by the context in which such term is used.

“Against the rule toricity” refers to a regular toric cornea wherein the two principal meridians are perpendicular to each other but the horizontal meridian is more curved than vertical meridian, of which the horizontal meridian means a range of 0 to 30 degrees, or 150 to 180 degrees.

“Against the rule tilting” refers to a cornea where the axis of tilting is in the vertical meridian, of which the meridian means a range of 60 to 120 degrees. “With the rule tilting” refers to a cornea where the axis of tilting is in the horizontal meridian, of which the meridian means a range of 0 to 30 degrees, or 150 to 180 degrees.

The “axial thickness” of a contact lens at a certain point radially outward from the geometric center of a contact lens means the axial distance between the front and back surfaces of the lens at that point of the contact lens 10, which can be determined by subtracting the sagittal height of the front surface from the sagittal height of the back surface at that point, and then adding the center thickness of the contact lens to that amount.

“Ametropia” refers to a refractive error in a subject's vision, i.e. an error in the focusing of light by the eye resulting in changed or reduced visual acuity. Examples of ametropia include myopia, hyperopia, and astigmatism.

“Back curvature” refers to a curvature of a back (rear) surface of a contact lens, i.e. the surface which contacts the eye of a subject.

“Base curve” means the curve or curves on a central portion of the back surface, or the optical zone, in a contact lens.

“Best-fit sphere” (BFS) refers to a sphere calculated by the method of the least root mean square of deviation used for elevation maps.

The “center thickness” is the distance between the front and back surfaces of a contact lens, at the geometric center of the contact lens.

“Central corneal astigmatism” can be classified as regular or irregular astigmatism. A regular corneal astigmatism is rotationally symmetrical against the corneal apex, though the curve is not rotationally uniform. In this case, the principal meridians of the cornea are always 90° apart from each other and there will be a consecutive variation in the refractive power from one meridian to another. Each meridian in the regular astigmatic eye has a uniform curvature at every point along the meridian while across the entrance of pupil. In irregular astigmatisms, the principal meridians are separated by any angle other than 90°, i.e., they are not perpendicular to each other. In this type, the curvature at each meridian is not uniform but changes from one point to another across the entrance of pupil. A small amount of irregular astigmatism is seen in every eye when the entire cornea is assessed; however, this is medically irrelevant when the irregularity locates out of the entrance of pupil.

A “central curve” is the radius of curvature of that portion of a contact lens which determines the refractive power of the lens.

A “Central Quadrant Design” contact lens is a single component contact lens that has four sets of base curves for the central back surface of the lens, wherein each set of base curve is associated with a sub-axis that all the four sub-axis are separated by 90 degrees or orthogonal to each other. The four sets of base curves and sub-axis combinations are determined to conform to a measured shape of the cornea for lens orientation, as that lens defined in U.S. Pat. No. 7,296,890.

“Edge thickness” refers to the axial thickness measured at the most peripheral portion of the contact lens. The edge thickness can be calculated by adding the front sagittal height and the center thickness of the lens minus the back sagittal height.

“E-value” refers to a measure of corneal eccentricity, with a value of zero indicating a perfectly spherical cornea. A negative e-value indicates a flat central zone with a steep mid-periphery (oblate surface), while a positive e-value indicates a steep center and flattens radially outward (prolate surface).

“Front curvature” refers to a curvature of a front surface of a contact lens, i.e. the surface, which faces away from the eye of a subject.

“Front optical zone” means the centermost portion of the front surface of a contact lens extending radially outward from its geometric center to the surrounding junction. The front optical zone can have a front curvature known as a “power curve”.

“Front peripheral zone” means an annular front surface coupled to and extending radially outward from the front optical zone, having a front curvature known as a “front peripheral curve”.

“Oblique astigmatism” refers to a regular toric cornea wherein the two principal meridians are not the horizontal or vertical but these are perpendicular to one other, of which the meridians range is 30 to 60 degrees, or 120 to 150 degrees.

“Optical zone” means the centermost portion of a contact lens extending radially outward from its geometric center to a surrounding junction, having a back surface with a curvature known as a “base curve”.

“Orthokeratology” and “ortho-k” refer to a planned application of a series of contact lenses to a subject to improve vision through the reshaping of the cornea.

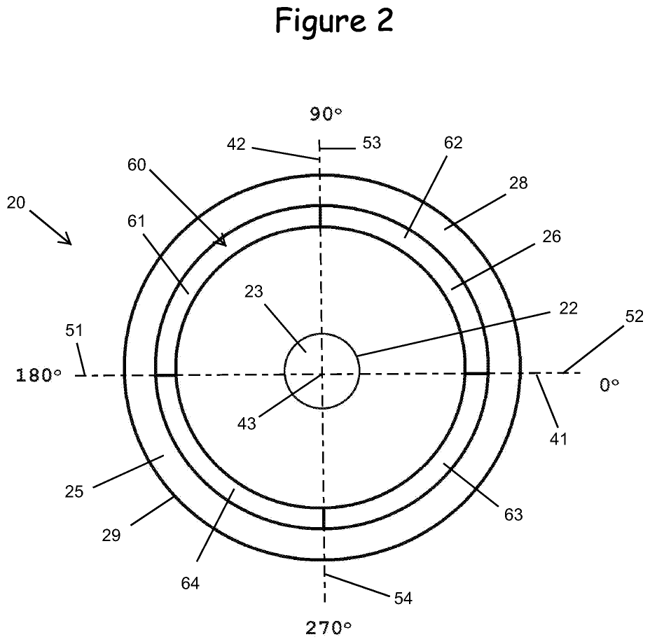

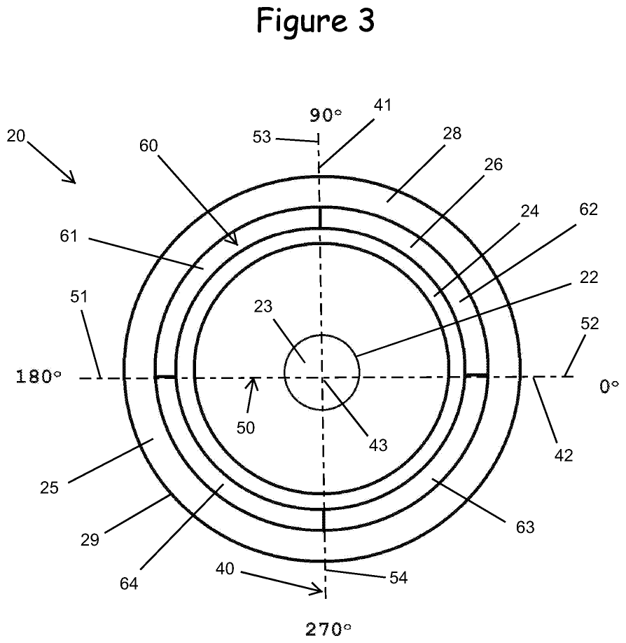

“Orientation angle” refers to a number of angles between 0° and 360° to indicate the orientation of a lens on a cornea or a topography of the cornea. When facing the corneal surface or topography, the orientation angle increases progressively counterclockwise from 0° to 360°. The 0° is set to the right side of the examiner (as shown in FIGS. 2 and 3), then counterclockwise and orthogonal to 0° at the upper side is 90°, and further counterclockwise to mirror the 0° is 180°, then further counterclockwise to mirror 90° at inferior side is 270°. The 0° direction can be set oblique to the horizontal meridian in case the corneal toricity or tilting is oblique, and dial counterclockwise from the oblique 0° angle as aforementioned.

“Orientation control” of a contact lens means to limit lens rotation when worn on an eye, for example to allow the cylinder power or a thicker sector of a lens to orient stably in a desired axis.

“Peripheral ocular irregularity” refers to the annular irregularity assessed out of the entrance of the pupil that can be assessed radially outward to the corneal margin, limbal area or adjacent scleral portion. The peripheral ocular irregularity of the cornea is usually determined by measuring an elevation map using a corneal topography. The value on the elevation map represents the height of the analyzed corneal surface with respect to a reference surface. Trial fitting, a topographer, or optical coherence tomography (OCT) can determine ocular irregularity up to the adjacent scleral portion.

A “Peripheral Quadrant Design” (P-Qdrt) contact lens is a lens with a plurality of components that has a base curve for the central optical zone 22 portion of the contact lens 20, where the base curve is not designed to conform to the measured shape of the cornea for orientation control, while it can be formed in any geometrically possible shape which is desired for ortho-k molding or optical correction. The lens includes at least an alignment zone 26 with four sets of alignment curves composing the annular peripheral portion of the back surface of the contact lens 20, extending radially outward from the junction with the optical zone 22 with a base curve, or from a junction with the intermediate zone(s) 24, wherein each set of alignment curves is associated with a sub-axis, where four sub-axes are separated by 90 degrees or orthogonal to each other. The four sets of alignment curves within sub-axes are carefully determined for the peripheral portion of the lens to bear on the peripheral portion of the ocular surface and connect all alignment curves with progressive curvatures for an uneven but smooth and continuous annular alignment zone 26.

The term “peripheral alignment” refers to the use of the present Peripheral Quadrant Design (P-Qdrt) contact lens, with the lens sagittal height of each sub-axis matching the sagittal height of the eye in every corresponding sub-axis, such that the peripheral portion of a contact lens bears on the peripheral portion of the corneal or scleral surface closely for water seal, which is important for fitting ortho-k, RGP and scleral lenses on the irregular cornea or sclera.

“Power curve” means the curve or curves on a central portion of the front surface, or the front optical zone, in a contact lens.

A “rigid contact lens” is one whose surface does not change shape so as to assume the contour of a corneal surface. Rigid lenses are typically made from PMMA [poly(methyl methacrylate)] or from gas-permeable materials such as silicone acrylates, fluoro/silicone acrylates, and cellulose acetate butyrate, whose main polymer molecules generally do not absorb or attract water.

“Sagittal height” refers to the height of a plane cutting through the geometric center of the back surface of a contact lens or the front surface of an ocular surface, wherein the height is measured from the dome apex to the plane of the zone of a contact lens or ocular surface to be measured. The sagittal height of a contact lens can refer to a front sagittal height or to a back sagittal height. The front sagittal height of a lens at a certain point means the vertical distance measured from the front surface at that point to the horizontal plane intersecting the most peripheral margin of the front surface of a lens. The back sagittal height of a lens at certain point means the vertical distance measured from the back surface at that point to the horizontal plane intersecting the most peripheral margin of the back surface of the lens. In the absence of a referent, “sagittal height” generally means the back sagittal height.

A “scleral lens” also known as a scleral contact lens, is a large rigid contact lens that bridges the cornea completely and rests on the sclera and that creates a tear-filled space between the back surface of the lens and the cornea.

A “soft contact lens” is one that is formed from a material whose surface generally assumes the contour of a corneal surface when placed onto a cornea. Soft contact lenses are typically made from materials such as HEMA (hydroxyethylmethacrylate) or silicone hydrogel polymers, which contain about 20-70% water.

The “thickness difference” for meridians or quadrants refers to the difference in axial thickness by comparison of the thickest portion of the thicker meridians or quadrants with the thinnest portion of the thinner meridians or quadrants of the contact lens.

“Tilting,” with reference to a cornea or sclera, means an ocular surface, including the cornea and/or adjacent sclera, having a different elevation height in one or more quadrants so that the curvatures of the meridians passing through the geometric center of the cornea are not rotationally symmetrical. The meridian passing though the geometric center of the cornea that separates a steeper and the flatter half is the “axis of tilting”. The cornea or sclera tilting can be measured with commercially available devices, including but not limited to the topography, 3D map or OCT. The elevation height in tilt corneas can be determined by topography, up to a zone width of 6-10 mm, and the measured information can be incorporated for Peripheral Quadrant Design (P-Qdrt) in regular RGP and ortho-k lenses. Trial lenses or OCT can be used to determine scleral tilting up to 15-22 mm zone width for sclera lenses or soft contact lenses.

“Upright control” refers to the use of a Peripheral Quadrant Design (P-Qdrt) contact lens of the present invention, in which the lens sagittal height of each sub-axis matches the sagittal height of an eye in the corresponding sub-axis, such that the geometric center of a contact lens may intersect the geometric center of the corneal apex for an upright and tangential position, which is important for fitting ortho-k, RGP or scleral lenses on the irregular cornea or sclera.

“With the rule astigmatism” refers to a regular toric cornea wherein the two principal meridians are at perpendicular to each other but vertical meridian is more curved than horizontal meridian, of which the vertical meridian means a range of 60 to 120 degrees.

A “zone” is a partially or completely circumferential region of a contact lens. A “quadrant” refers to a portion of such a zone. Typically, a zone will also have a back surface that comprises a back curve with a particular radius of curvature, with or without an e-value. However, a zone can also comprise a plurality of curvatures having a particular e-value or forming one or more defined curvatures such as an aspheric curve or S curve.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. Terms of position or distance, such as “horizontal,” “vertical,” “upper,” “lower,” and the like are intended to be relative terms unless otherwise indicated.

Equations

“Sagittal height equation (S)” is derived by S=R/P−SQRT((R/P)²−(D/2)²/P), where R is the measured central curvature of a spherical or aspheric surface; D is the zone diameter of the surface; e is the e-value of the surface; and P is derived from e by the equation P=1−sign(e)*e².

“Oblique astigmatism powers” equation to estimate the oblique astigmatism power of a toric power T (in diopters), the equation for a deviation angle X°, is O=T*SIN((X°)*PI( )/180)\hat{ }2. The equation for the oblique astigmatism power (P) at an angle orthogonal to the angle X° is P=T*COS((X°)*PI( )/180)\hat{ }2.

To determine the “sagittal height of an annular zone” (S_{az}), the equation is S_{az}=S₂−S₁, where the sagittal height of outer zone diameter is S2 and the sagittal height of inner zone diameter is S1.

For “converting sagittal height to curvature,” the equation is: radius of curvature=SQRT(((S²+(D₂/2−D₁/2)²+D₁*(D₂/2−D₁/2))/2)²/S²+(D₁/2)²)), wherein “D₂” is the zone width of outer zone, and “D₁” is the zone width of inner zone, S is the sagittal height of the annular zone between the outer and inner zone.

### DETAILED DESCRIPTION

The object of the present invention is directed to provide a contact lens and a method for making contact lenses. More specifically, the present invention is directed to a contact lens that offers a design for peripheral portion of the contact lens to achieve orientation control, upright control or peripheral alignment. The central optical zone of the contact lens is freed up and can be predetermined freely in any geometric possible shape for ortho-k molding or vision correction without conforming to the shape of the central portion of the cornea.

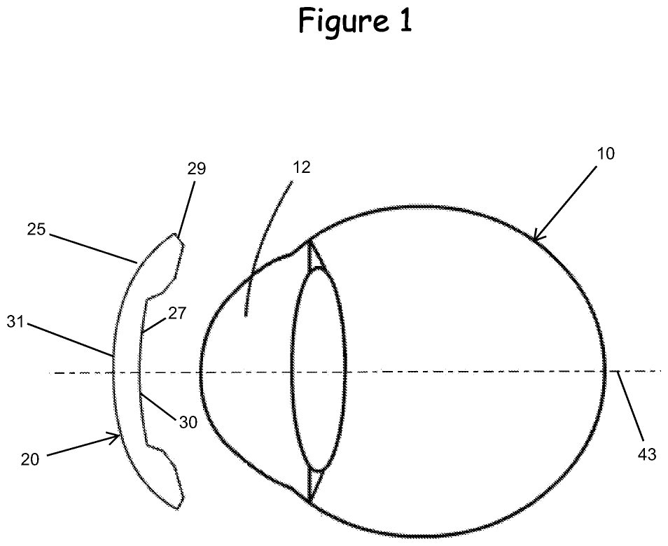

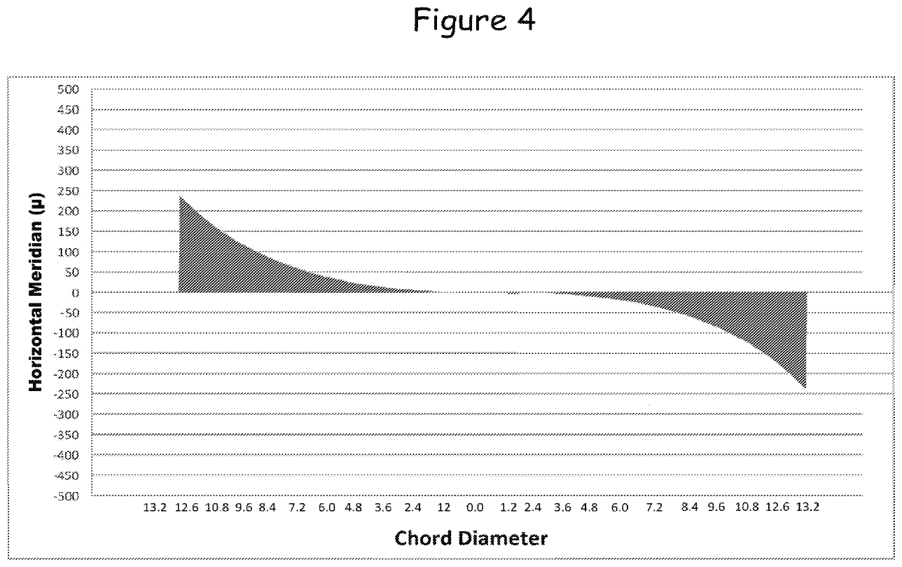

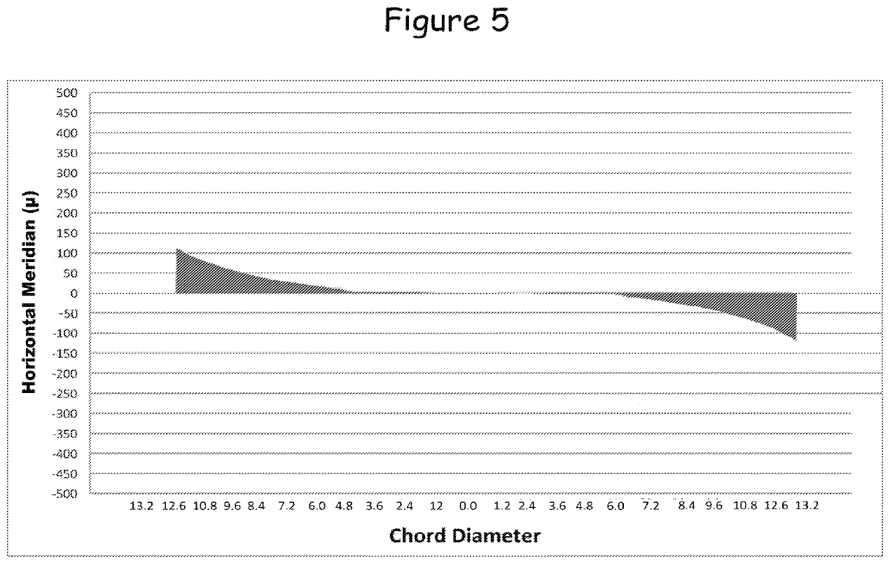

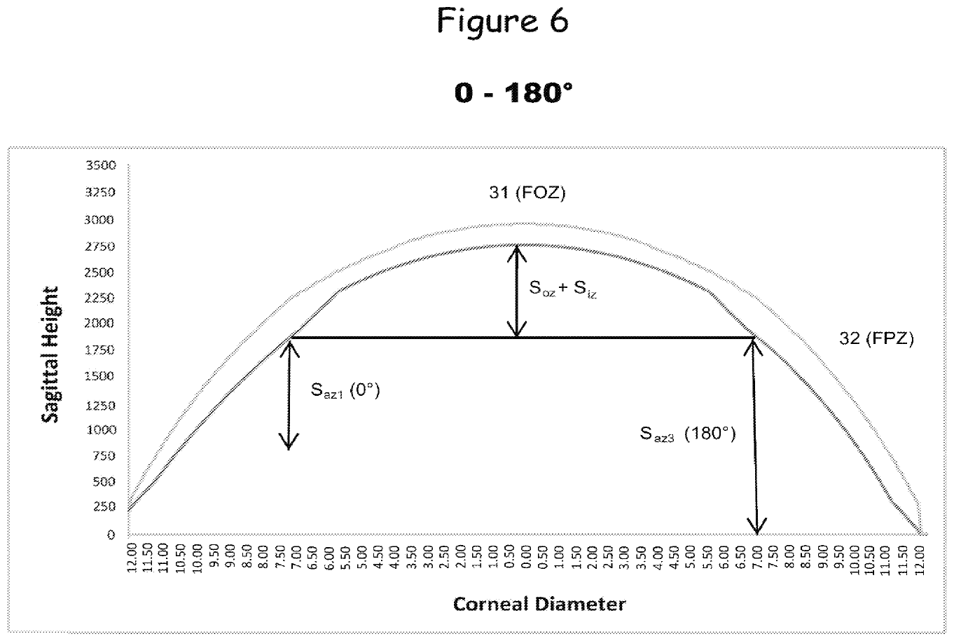

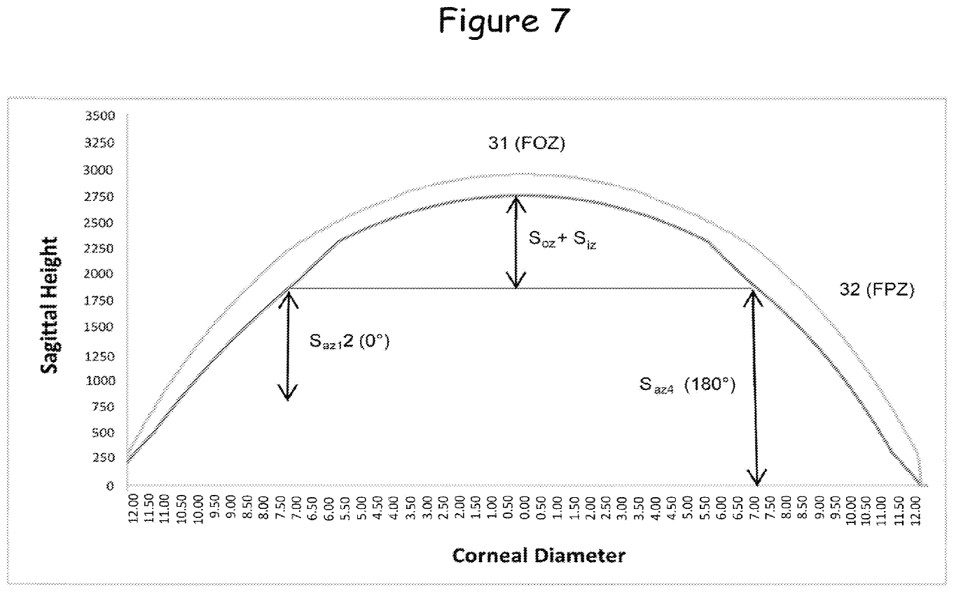

FIGS. 1-3 and 6-7 illustrate a P-Qdrt contact lens 20 according to one embodiment of the present invention. The contact lens 20 has an optical zone 22, an optional intermediate zone 24 (shown in FIG. 3), an alignment zone 26, and a peripheral zone 28. As shown in FIG. 1, the contact lens 20 is a P-Qdrt contact lens that is adapted to be worn over the cornea 12 of a patient's eye 10. An example of the elevation information for such a lens is illustrated in FIGS. 4 and 5.

A spherical coordinate system can be used to describe the shape of a contact lens 20. FIGS. 2 and 3 illustrate a contact lens 20 having X-axis 41, a Y-axis 42, and a Z-axis 43, which can be the optical axis when the lens is being worn on an eye, as seen in FIG. 1. Each axis is preferably orthogonal (perpendicular) to the other, such that a ninety degree angle exists between each axis, and any two such axes are in the same plane. The X-axis 41 and Y-axis 42 lie in a plane in which the lowest point of the edge of the contact lens is also located. The coordinate system described by the X-axis 41, Y-axis 42, and Z-axis 43 is a Cartesian coordinate system.

Each axis 40 can be subdivided into two sub-axes 50. For example, the X-axis 41 can be divided into a first sub-axis 51 and a second sub-axis 52, and the Y-axis 42 can be divided into a third sub-axis 53 and a fourth sub-axis 54, as illustrated in FIGS. 2 and 3. Each axis thus comprises two opposed radial lines extending from the intersection of the axes.

The contact lens 20 has an alignment zone 26, and as can be seen in FIGS. 2 and 3, the sub-axes 51-54 can be said to divide the alignment zone 26 into 4 quadrants 60, namely a first quadrant 61 (Q1), a second quadrant 62 (Q2), a third quadrant 63 (Q3), and a fourth quadrant 64 (Q4). The back curvatures and sagittal heights of the alignment zone 26 are different than those of the optical zone 22 of the contact lens 20. In addition, each of the sub-axes 51-54 can have a different curve and different sagittal height in the portion of such sub-axes which is within the alignment zone 26, with at least one of the sub-axes in the alignment zone having a different predetermined sagittal height and/or curvature than the sagittal height and/or curvature of at least one other sub-axis within the alignment zone. The back curves within the quadrants 60 of the alignment zone 26 between adjacent sub-axes (e.g., between sub-axes 52 and 54) are connected for a smooth, annular alignment curve of the back surface of the contact lens 20, as known to one skilled in the art such as an engineer for programming a lathe machine for cutting contact lenses. In one embodiment, the back curvatures and/or sagittal heights of three quadrants are the same and one quadrant different. Alternatively, the back curvatures and/or sagittal heights of all 4 quadrants can be different from each other. In combination, for example, the back curvatures and/or sagittal heights of the quadrants can be as follows: Q1=Q3 and Q2=Q4 but Q1 and Q3≠Q2 and Q4; (2) Q1=Q2 and Q3=Q4 but Q1 and Q2≠Q3 and Q4; (3) Q1=Q2=Q3≠Q4; (4) Q1≠Q2≠Q3≠Q4; (5) Q1≠Q3 but Q2=Q4; and (6) Q1≠Q2 but Q3=Q4.

The optical zone 22 of an ortho-k contact lens 20 for reducing myopia has a curvature that is defined by the base curve 30, of which the optical zone 22 applies a primary compressive force to a region substantially centered at the apical center of the cornea 12, and is responsible for the corrective flattening or decrease in the radii of curvature of the central portion of the cornea 12 during treatment. The radius of curvature of the base curve 30 is greater (longer or flatter) than a measured curvature of a central portion of the cornea 12 and creates a central bearing area where a primary compressive force is applied during vision correction. In other words, the curvature of the base curve 30 is flatter than a measured curvature of the central portion of the cornea 12. In one embodiment of the present invention for P-Qdrt ortho-k lens to correct myopia, the diameter of the optical zone 22 ranges from 3 mm to 10 mm, and the radii of the curvature for the base curve 30 ranges from 15.0 mm to 7.0 mm.

The optical zone 22 of an ortho-k contact lens 20 for reducing hyperopia has a curvature that is defined by the base curve 30. The optical zone 22 forms a suitable space for molding tissue to a region substantially centered at the apical center of the cornea 12, and is responsible for the corrective steepening or increasing in the radius of curvature of the central cornea during treatment. The radius of curvature of the base curve 30 is smaller (shorter or steeper) than a measured curvature of a central portion of the cornea 12 for treatment of hyperopia, thus creating a central tenting up area to provide a suitable space for piling the cornea tissue during vision correction.

The optical zone 22 in the invention can be divided into two portions for the treatment of presbyopia coupled with myopia or hyperopia. In this embodiment, a relatively small inner additive optical zone 23 is used that has an inner additive base curve which is steeper (shorter radii) than the consecutive base curve 30 by 1-4 diopters. The outer optical zone 22 defined by the base curve 30 is steeper (shorter radii) than the central curvature of the cornea 12 by 1-15 diopters. The tented-up spacing under the outer optical zone 22 causes the cornea molding to form a steeper juxta-central portion of the cornea 12 for correcting hyperopia, and the even steeper inner optical zone 23 causes the formation of an even steeper curvature of the central portion of the cornea 12 for correcting presbyopia. The inner optical zone 23 is preferably kept small enough to prevent it from hindering far vision and the size is usually from 0.5 mm to 1.5 mm. There could be a substitution for dividing the optical zones for presbyopia reduction, by creating an aspheric base curve 30 with positive eccentricity (e-value), so that the curvature of the inner portion of the base curve 30 will be substantially steeper than that of the outer portion of the base curve 30.

Knowing the peripheral contour of an eye is important for designing contact lenses, especially contact lenses made from rigid materials such as RGP, ortho-k and scleral lenses. It is well known to contact lens designers that the optical center, usually the geometric center of the contact lens, has to coincide with the geometric center of the cornea 12 so that the optical axis of the contact lens can align with the visual axis of the eye 10. A decentered contact lens may cause vision problems and discomfort, such as fluctuation, halo or glare of the vision and ocular irritation. Besides centering the contact lens 20 well on the cornea 12, it is also required to keep the optical zone 22 of the contact lens 20 covering the corneal center in an upright position to intersect the corneal apex tangentially. In other words, the tangential plane of the optical zone 22 of the contact lens 20 should be orthogonal to the visual axis of the eye 10 for upright control, which is especially important for ortho-k and scleral lenses.

If the tangential plane of the optical zone 22 of an ortho-k contact lens 20 is inclined and not orthogonal to the visual axis of the eye 10, the force of the back surface of the contact lens 20 bearing on central portion of the cornea 12 will be distributed unevenly and form an inclined/tilted treatment zone, which may induce astigmatism or an irregular surface with poor vision. Placing the optical zone 22 of a rigid contact lens 20 inclined or tilted, more specifically if it is a scleral lens, may induce oblique astigmatism or corneal aberration that may interfere with vision profoundly while a subject wears the contact lens 20, even though centration might be good. The ocular surface of the cornea and adjacent scleral portion of the eye 10, is usually not rotationally symmetrical in all meridians. There could be an unlimited combination of curvatures and eccentricity in all meridians, quadrants or annular zones of the eye 10. Hence, there is still a need for P-Qdrt contact lenses for significantly inclined or tilted corneas, especially for ortho-k or scleral contact lenses.

There are variety commercially available devices for ocular surface measurement to determine the ocular shape, and convert the measured information for lens design. The present invention of Peripheral Quadrant Design (P-Qdrt) lenses, the base curve(s) 30 of the optical zone 22 does not conform to the central ocular surface of the eye 10, while instead the invention teaches to equalize the corneal sagittal height among all sub-axis or quadrants by the alignment zone 26 of the contact lens 20, and makes the optical zone 22 of the contact lens 20 upright to bear on the ocular surface of the eye 10 rotationally uniformly.

The base curves 30 of the contact lens 20 and peripheral zone of present invention can be predetermined for any purposes such as flatter or steeper than the central corneal curvature or made toric, but not conforming to the corneal shape, to execute ortho-k molding of the cornea 12 to correct myopia, hyperopia, or astigmatism, including internal astigmatism. It is also possible to predetermine a rotationally single curve spherical or aspheric base curve 30, or any geometrically possible base curves for optical correction in a regular RGP lens, scleral lens or soft contact lens. The sagittal height difference among all sub-axes or quadrants is implanted in the alignment zone(s) 26 of the back surface of the contact lens 20 by providing four sets of alignment curves within the sub-axes, adjacent to and radially outward from the optical zone 22 or intermediate zone 24. The 4 sets of alignment curves and sub-axes are determined through a sagittal height calculation for orientation control and/or upright control, and may also bear the peripheral portion of the contact lens 20 intimately on the peripheral portion of the ocular surface of an eye 10 to improve lens centration and peripheral alignment. The plurality of sets of alignment curves are connected with progressive curvatures for an uneven but smooth and continuous annular alignment zone 26.

Another object of the present invention is to provide the contact lenses 20 for orientation control. Most conventional contact lenses are rotationally symmetrical and may rotate freely on the eye without orientation. The prior understanding of the Central Quadrant Design lens orients a contact lens for creating astigmatism power and/or lens axial thickness on a front surface of the contact lens. The Central Quadrant Design conforms the base curve of the back central surface of the contact lens to the central curvature of the cornea surface for orientation, to enable fabrication of the astigmatism power or lens axial thickness on a fixed meridian or quadrant. This methodology may orient the contact lens for vision correction but cannot be applied in ortho-k lenses for corneal molding that also needs lens orientation. The base curve(s) 30 of an ortho-k contact lens 20 cannot be shaped to conform to the central cornea for any reason, otherwise the base curves won't be able to change the central portion of the cornea into a desired shape, for which the lens will exert planned forces via the base curve portion of the contact lens 20, to change the corneal shape. The optical zone 22 with the base curve(s) 30 of the ortho-k contact lens 20 is usually made flatter than the central curvature of the cornea 20 for molding myopia, or steeper than the central curvature of the cornea 20 for molding hyperopia. In more advanced ortho-k molding for presbyopia, the base curve 30 of the contact lens 20 has to be formed progressive for reshaping central near (CN) or central distance (CD) multifocal vision.

The central corneal toricity can usually be molded into a spherical and non-toric central cornea with an ortho-k contact lens 20 having a rotationally spherical or aspheric optical zone 22 with the base curve 30. In very specific conditions, there could be internal astigmatism that a single set of spherical or aspheric base curves cannot mold off the internal astigmatism. In this case an optical zone 22 can be fabricated with a toric base curve 30 having an axis orthogonal or oblique to that of the corneal toricity, while orienting the toric base curve by the P-Qdrt design of the present invention on the alignment zone 26, to reconstruct the central cornea for a toricity different in power and/or axis from that of the pristine cornea 20 to correct internal astigmatism. In this instance, the base curve(s) 30 of the optical zone 22 can be toric or quadrant but will not conform to the pristine central cornea 20, as was described in prior art U.S. Pat. No. 7,296,890.

The P-Qdrt lens of present invention may provide orientation control while freeing up the base curve of the central back surface of the contact lens 20, for any shape that is desired for ortho-k molding as aforementioned. Orientation control is needed in a variety conditions of ortho-k molding, including but not limited to molding a highly toric or inclined cornea that need peripheral alignment in sub-axes or quadrants, and for that of the aforementioned ortho-k molding with internal astigmatism, of which the base curve(s) 30 can be created toric but in a different power or axis for molding off the residual astigmatism without conforming the central shape of the cornea 12.

For orientation control in regular RGP and scleral lenses, the P-Qdrt design of the present invention is also more convenient and superior in optical quality. The corrective power of a regular RGP or scleral lens is ground on the front surface of the contact lens, which is also called the “power surface”. The power equation for the front and back surface of the lens is P=[1000*(n2−n1)]/R, of which the P is lens power in diopters, n2 is the refraction index of the material the light enters and n1 is that of the material the light is coming from. The refraction index n of the lens material (usually about 1.45˜1.50) is significantly different from that of the tear (n=1.336) and cornea (n=1.3375). When putting rigid lenses on a cornea 12, there will be tear fluid filling up the optical zone 22, which may neutralize almost all of the corneal toricity if the base curve is a rotationally single spherical or aspheric curve since the refraction index of tears (1.336) is very close to that of the cornea (1.3375) and the refraction power between the interface can be neglected since n2=n1 and P=[1000*(n2−n1)]/R≈0. Single base curve makes it straightforward and easy to obtain the lens power and residual astigmatism to be ground on the front surface of the contact lens 20. While if there are two or plurality of sets of base curves on the optical zone of a Central Quadrant Design for orientation control, the refraction indices between the lens material and tear fluid (e.g. 1.45 vs. 1.336) may be significant enough to induce astigmatism or aberration among sub-axis among different base curves. The P-Qdrt lens with a single base curve provides a simpler and more predictable way to obtain the cylinder power to be ground on the power (front) surface of the contact lens 20, while still providing the orientation control with the alignment zone 26.

There is yet another object of present invention to provide the contact lenses 20 for controllable peripheral alignment. The peripheral contour of a contact lens is important in several aspects, wherein the most important role in ortho-k lens is to provide peripheral water sealing for the peripheral portion of the contact lens 20 to bear on the peripheral portion of the cornea 12 to exert effective inward pushing force. The peripheral contour of the regular RGP lens, scleral lens or soft contact lens also needs peripheral alignment, though not for exerting pushing force for cornea molding. Peripheral alignment is required for lens centration to keep the central portion of the contact lens aligning accurately with the visual axis for clear vision. The peripheral alignment of a contact lens is also critical for comfort and corneal health of all kinds of contact lenses, including regular RGP, scleral, and ortho-k contact lenses, as well as all kinds of soft contact lenses.

Peripheral alignment can be used for lens centration, while the base curve 30 or central optical zone 22 of the contact lens 20 can be made in any reasonable shape or sagittal height for different purposes, including but not limited to a curve flatter or steeper than that of the corneal curvature to bear on or vault the central portion of the cornea 12, while the peripheral portion of all kinds of contact lenses have to bear on the peripheral portion of the ocular surface securely for corneal molding or vision centration. The conventional contact lenses usually create the back surface of a contact lens with a nomogram for one or plurality of progressively flatter intermediate zones, or alternatively fusing the plurality of zones with a single progressively flatter aspheric curve, to bear the lens on the peripheral portion of the cornea gently and comfortably. The outermost zone of a contact lens, or the peripheral zone 28, is usually designed slightly elevated from the ocular surface for the peripheral curve, to provide fluid exchange, of which the edge-lift height and edge shape is critical for fluid exchange and less irritation to the eye 10.

While most ocular surfaces are not regular, the corneal or scleral portion of the eye 10 may be toric or inclined in some sub-axis or quadrant even in an eye which looks normal. Irregularity may increase abruptly in some ocular diseases, post surgery or trauma, such as the keratoconus, pellucid marginal degeneration, post refractive surgery, or post penetrating corneal transplantation (PKP) etc. The nomogram for forming evenly curved annular zones does not work in eyes with irregular peripheral ocular surfaces. There is a need for more sophisticated ways to measure the ocular irregularity and adapt contact lenses appropriately, which is especially important for construction of the peripheral portion of the present contact lens 20, aiming to bear the contact lens 20 properly on a peripheral portion of an irregular ocular surface for centration, ocular health and comfort on the eye 10.

Different kinds of contact lenses may require different design features for peripheral alignment. Regular RGP lenses, whose the lens size is smaller than the corneal size, will need fluid exchange, so that it is preferable to create sagittal height differences among sub-axes partially for incomplete water sealing with fluid exchange in the vertical meridian. For with the rule corneal astigmatism higher than 3 diopters, the corneal sagittal height of the vertical meridian is significantly deeper than that of the horizontal meridian and may need P-Qdrt periphery, for which the elevation height difference should be equalized only for 30% to 80% for better lens centration while leaving some tear space in the lens edge for fluid exchange.

In ortho-k lenses for highly toric or inclined corneas, the lens size is smaller than the corneal size, but the alignment zone 26 of the contact lens 20 is designed to bear on the peripheral portion of the cornea 12 intimately for water sealing rotationally 360 degrees without fluid leaking. If the fluid leaks, the corneal tissue would be redistributed to the leaking sector, which is usually at a lower portion of the cornea to form a corneal topography like a smiley face, leading to poor vision. Hence in ortho-k, the P-Qdrt ortho-k contact lens 20 has to match nearly 100% the elevation height difference in all quadrants for complete peripheral alignment.

The size of a scleral contact lens 20 is always bigger than the cornea 12 of the eye 10, of which the lens sagittal height is designed deeper than the ocular sagittal height to form a space between the posterior surface of the contact lens 20 and the front surface of the cornea 12. There are at least 3 back curvatures in the scleral contact lens that are, an optical zone 22, one or plurality of intermediate zones 24, and one alignment zone 26 for adjusting the sagittal height, and a peripheral zone 28 for bearing a peripheral portion of the scleral contact lens 20 on the scleral portion of the eye 10. The whole optical zone 22 with the base curve 30 of the scleral contact lens 20 should be designed to tent up with no touching of the whole cornea 12, while the base curve 30 of the optical zone 22 can be designed in any shape or curves that form a central tear layer space between 50 to 400 microns. The intermediate zone 24 and alignment zone 26 adjacent to and radially outward from the optical zone 22 are the zones for adjusting the total sagittal height for a scleral contact lens 20 to vault the whole cornea, including and slightly beyond the limbus. The scleral contact lens 20 should not bear on any sector of the midperipheral portion of the cornea 20. The alignment zone 26 connects radially outward to the peripheral zone 28, which touches and bears gently on the bulbar conjunctiva over the scleral portion of the ocular surface of the eye 10. The peripheral zone 28 of the scleral contact lens 20 should touch the scleral portion of the eye 10 for gentle and intimate peripheral alignment, while the edge of the scleral contact lens should not indent the overlaying conjunctiva over 50% of the edge thickness nor blanching the vessels or restricting blood flow, and the lens edge should not lift up to cause irritation. It is not uncommon that the adjacent scleral portion of the eye 10 may have small bumps known as pinguecula, or have significant scleral toricity, then the P-Qdrt design with a plurality of sets of alignment zone curves may bear the peripheral zone 28 of the scleral contact lens 20 more properly on the scleral portion of the eye 10. The alignment zone 26, adjacent to and radially outward from the outer margin of the optical zone 22 or intermediate zone 24, is figured to adjust the sagittal height of the scleral contact lens 20 for forming proper tear space between the posterior surface of the scleral contact lens 20 and the front surface of the cornea 12. A properly designed scleral lens should form a tear layer of 50 to 400 microns at center with no bearing on the front surface of whole cornea 12. The tear space should extend up to and slightly beyond the limbus on the eye 10. For a very irregular ocular surface like a severe keratoconus, the posterior surface of the scleral lens may touch the cornea in one sector or quadrant but have excessive pooling in another sector or quadrant, which can be adjusted for a more even tear layer using the P-Qdrt design with a plurality of sets of alignment curves. The plurality of sets of alignment curves of the alignment zone 26 can be blended into an uneven but rather smooth, continuous annular alignment zone 26.

The peripheral zone 28 of a P-Qdrt rigid contact lens 20, having a peripheral curve on the back surface, couples to and therefrom the alignment zone 26. The peripheral zone 28 can have only a single set of curvatures, but will be sill rotationally uneven, connecting the uneven alignment zone 26 as aforementioned. For rigid contact lens 20, including but not limited to the regular RGP, ortho-k or scleral lenses, the front peripheral zone of the contact lens 20 can be designed unevenly to follow the back peripheral zone 28 to form an edge with rotationally uniform thickness. A rigid contact lens 20 with rotationally uniform edge thickness will be more comfortable than that of bumping edge.

The size of a soft contact lens peripheral zone is generally bigger than the cornea 12 and covers beyond the limbus up to the adjacent scleral portion of the eye 10. A soft contact lens peripheral zone is pliable, draping the cornea 12, and may have good centration even if the ocular surface is slightly irregular. There is still a need however to design a P-Qdrt soft contact lens of the present invention for better peripheral alignment if the ocular surface is extremely irregular, including but not limited to a keratoconus, pellucid marginal degeneration or ocular trauma involving the limbal or scleral portion of the eye 10. The P-Qdrt lenses for peripheral alignment in a soft contact lens peripheral zone is different from the structure in a traditional toric soft contact lenses for orientation control as aforementioned. The P-Qdrt soft contact lens peripheral zone uses a plurality of sets of predetermined corneal sagittal heights with sub-axes to create the peripheral contour of a soft contact lens, of which the sagittal height differences can be implemented either on the front surface or back surface of the contact lens 20. The soft contact lens material is pliable and the back surface shape can be transposed to the front surface, and vice versa. The edge (outer periphery) of a P-Qdrt soft contact lens peripheral zone is preferably made rotationally uneven in edge thickness, complementary to the ocular sagittal height difference of the adjacent quadrant 60 and/or sub-axis 50. The front surface of the eye 10 wearing such a soft contact lens will become rotationally uniform in the front surface. Hence, the front peripheral curve of the front peripheral zone in a P-Qdrt soft contact lens peripheral zone is made rotationally uniform, and does not to follow the uneven curvature of the back surface, or vice versa, to create a front peripheral curve which is uneven and a back surface which uniform in shape, to elicit the complementary uneven edge thickness, for peripheral alignment.

In designing such a lens, the ocular sagittal heights of a wearer's eyes should be determined in all meridians or quadrants, to deduce the peripheral curves of the P-Qdrt contact lens 20. For a “Central Quadrant Design” described in prior wisdom of U.S. Pat. No. 7,296,890, it is straightforward to design the base curve(s) of a contact lens to conform the measured corneal shape for orientation control. The Peripheral Quadrant Design (P-Qdrt) designs spare the central base curve(s) for a plurality of purposes, and use the peripheral back surface of a contact lens 20 or peripheral zone for peripheral alignment, upright control and orientation control.

The fitting procedure is to reconstruct the corneal contour for designing the contact lens 20 or peripheral zone by using the ocular sagittal heights and elevation data obtained from a topographer, 3D map, OCT, or a standard trial set of lenses with known sagittal heights. Then, we use the sagittal heights and elevation data within sub-axes to derive a plurality of sets of alignment curves for the sub-axes of the alignment zone 26.

The general concept of sagittal height calculation in designing the P-Qdrt contact lens 20 is to obtain the corneal sagittal height for all quadrants with sub-axes in a topographer. It is also possible to derive the ocular sagittal heights by the measured corneal curvatures and shape factors, (i.e. e-value, p-value, or q-value), for which we usually check 4 quadrants up to the maximum reliable annular zone. The formula to derive ocular sagittal height from the measured curvature, and the shape factor, are well known to lens designers. The corneal sagittal height measured in this way can be confirmed with a standard trial set, wherein the lens sagittal height has been predetermined, as is known to practitioners.

While determining ocular sagittal height for a scleral lens to bear on a sclera surface properly, the regular topographer does not measure the contour beyond limbus. We can use trial lenses with predetermined lens sagittal height to test and reconstruct the corneal sagittal height for designing the P-Qdrt scleral contact lens 20. After trial fitting we can adjust the quadrant sagittal heights by observing the peripheral edge lifting, edge pinching, indentation, or tear layer thickness with a slit lamp and fluorescein stain, or by OCT (ocular computer tomography). Some new topographers may be also available to interpret the ocular contour beyond the limbus and can be used in conjunction with the trial set as aforementioned, to determine the ocular sagittal height and elevation height differences in all quadrants or sub-axes on eye 10, for designing the P-Qdrt scleral contact lens 20.

For the P-Qdrt soft contact lens peripheral zone of the present invention, the ocular shape should be determined for fine tuning the edge thickness, in particular within sub-axes, for example with commercially available topographers, 3D maps, OCT, or a trial lens set with different quadrant edge thicknesses.

In a P-Qdrt lens of the present invention, the sagittal heights of the alignment zone 26 of the contact lens 20 and peripheral zone are preferably made to match the predetermined sagittal heights and the height differences of the measured cornea surface 12 or ocular surface of the eye 10 of a user for all sub-axes and quadrants, so that the lens will rotate automatically to lock down securely in the right direction without extra design for orientation when putting the lens on the eye 10. A skillful eye care practitioner can interpret the lens fitting by applying the fluorescein dye while fitting P-Qdrt rigid contact lenses to know if it fits well and whether the peripheral portion of the lens bears on the ocular surface properly. A drill dot or line mark at one sub-axis of a rigid or soft P-Qdrt lens, preferably on its front surface at 6 o/c (inferior), can also be used for easier identification, but it can be made at any indicated sub-axis that is known to the eye care practitioners (ECP). The drill or line mark is added for checking any small deviation angle when wearing the finished contact lens 20 or peripheral zone on the eye 10. The ECPs may adjust their prescription for the astigmatism power or axis incorporated on the front or back surface of a P-Qdrt rigid contact lens 20 or soft contact lens peripheral zone that require orientation control by P-Qdrt design of the present invention.

Converting measured ocular information for sagittal height calculation. The ocular information needed for designing P-Qdrt contact lenses 20 or the peripheral zone of the present invention is usually the measured corneal information from a topographer such as the corneal curvatures (KM), shape factors (e-value, p-value, or q-value), as well as the elevation height obtained from the elevation map. Commercially available topographers for corneal information are usually reliable for the corneal contour within about a 10 mm zone, while requiring extrapolation or the combining several images for a composite map to expand the measurable zone but still within the limbus. For the zone beyond the limbus, other devices can be used such as a 3D map or OCT, but the information might be less reliable than that of a topographer. The measured corneal information of corneal curvatures and e-value or p-value can be used to derive the corneal sagittal height with the formula well known to skillful lens designers. The equation 1 can be applied to derive the corneal sagittal height (S) of a cornea 12, having measured apical radius “R”; Shape factors e-value=e and P=1−sign(e)*e²; and the zone diameter “D”. The corneal sagittal height S=R/P−SQRT((R/P)²−(D/2)²/P). For each set of corneal sagittal height with sub-axis, the apical corneal radius R and e-value (or p-value) are usually available in one steepest and one flattest meridians that are orthogonal to each other. The corneal sagittal heights (Sₛ and S_{f}) of the two major meridians for the D zone can be derived with the equation 1, wherein Sₛ=Rₛ/Pₛ−SQRT((Rₛ/Pₛ)²−(D/2)²/Pₛ) and S_{f}=R_{f}/P_{f}−SQRT((R_{f}/P_{f})²−(D/2)²/P_{f}). To determine the quadrant sagittal heights for the P-Qdrt lens of the present invention, we also need to obtain the elevation heights in elevation map for the height differences among the 4 quadrants. The elevation map of the cornea derives the elevation height in reference to a “Best-fit sphere” (BFS), which is calculated and extrapolated through the cornea. The systems then calculate areas of “relative elevation” or “relative depression” base on the deviation from the BFS, and the deviation values are displayed in microns. The elevation above the BFS is plus in value and that depressed to the BFS is minus in value. The steeper sub-axis in map is usually colored in blue for depression to the BFS, while that of the flatter sub-axis is colored yellow or red for elevation above the BFS. The relative value of depression and elevation referring to BFS offers the required information, for sagittal height adjustment of the S, Sₛ and S_{f} obtainable in aforementioned method, to derive the quadrant sagittal heights within sub-axes as S₁, S₂, S₃ and S₄.

The S₁, S₂, S₃ and S₄ are the corneal sagittal heights to be converted to the curves for forming the back contour of the P-Qdrt lens for the peripheral portion of the lens to match the peripheral portion of the cornea 12 in a corresponding sub-axis. While the central base curve(s) 30 of the optical zone 22 is part of the lens sagittal height of the P-Qdrt lens, it is not designed to conform the central corneal shape but instead used for treatment or else functional purposes such as ortho-k, for which the base curve(s) 30 of the optical zone 22 is predetermined prior to designing the peripheral contour of the P-Qdrt contact lens 20. The equation 1 aforementioned is used to determine the lens sagittal height of optical zone S_{OZ}, wherein the base curve(s) BC, the optical zone width OZ, are applied for S_{OZ}=BC−SQRT(BC²−(OZ/2)²), if the base curve is spherical (P=1); or the p-value (P_{OZ}) is required if the optical zone 22 is predetermined aspheric, S_{OZ}=BC/P_{OZ}−SQRT((BC/P_{OZ})²−(OZ/2)²/P_{OZ}). There could be two orthogonal base curves if the optical zone 22 is formed toric for ortho-k lens to mold internal astigmatism, which can be figured by the equation 1

for each sub-axis, such that S_{OZ}1=BC¹/P_{OZ1}−SQRT((BC¹/P_{OZ1})²−(OZ/2)²/P_{OZ1}), and S_{OZ2}=BC¹/P_{OZ2}−SQRT((BC²/P_{OZ2})²−(OZ/2)²/P_{OZ2}).

The intermediate zone 24, adjacent to and radially outward from the optical zone 22, of the ortho-k lenses for treating myopia, hyperopia and/or presbyopia, is designed to have a sagittal height of S_{IZ}, derived from the best-fit corneal sagittal height BFS_{IZ}, measuring up to the outermost portion of the intermediate zone 24. The BFS_{IZ}, having the zone diameter of D_{IZ}, can be obtained by the aforementioned equation 1 with the R and P for the cornea 12. BFS_{IZ}=R/P−SQRT((R/P)²−(D_{IZ}/2)²/P). In one embodiment of the present invention of the ortho-k contact lenses, the sagittal height of the intermediate zone S_{IZ} of the contact lenses 22 is designed to have the zone sagittal height S_{IZ}=BFS_{IZ}−S_{OZ}, then converting the S_{IZ} to Intermediate curves IC by IC=SQRT(((S_{IZ}²+(D_{IZ}/2−OZ/2)²+OZ*(D_{IZ}/2−OZ/2))/2)²/S_{IZ}²+(OZ/2)²)) For the most common design, the optical zone 22 and intermediate zone 24 are both in single uniform curvature, the sagittal height of the peripheral back surface of the contact lens 20 S_{az1}, S_{az2}, S_{az3}, S_{az4} with sub-axis 0°, 90°, 180°, 270° degrees respectively, can be determined by S_{az}1=S₁−(S_{OZ}+S_{IZ})+K₁; S_{az}2=S₂−(S_{OZ}+S_{IZ})+K₂; S_{az}3=S₃−(S_{OZ}+S_{IZ})+K₃; S_{az}4=S₄−(S_{OZ}+S_{IZ})+K₄. Wherein the K₁, K₂, K₃, K₄ are factors for fine tuning the sagittal height in each meridian, such as but not limited to, for the P-Qdrt RGP that needs “partial peripheral alignment” to facilitate tear exchange with only 30% to 80% peripheral alignment for centration or orientation control. The extent of peripheral bearing can be adjusted by K₁˜K₄. The K₁˜K₄ factors may also be used to correct unwanted corneal bearing, conjunctiva pinching or excessive edge-lift in a scleral contact lens 20, for more or less edge-lift in one or two quadrants, for the peripheral zones to bear properly on ocular surface of the eye 10. The K₁˜K₄ values can be determined with a 3D map, OCT or trial fitting with a trial set by interpretation of the ocular bearing or edge lifting with an OCT or slit lamp. The criteria of appropriate edge-lift are well known to a skillful scleral contact lens fitter.

If there are a plurality of sets of base curves with sub-axes, as that of a myopic ortho-k lens for molding internal astigmatism, the sagittal height calculation can be more complicated. The principle is the same for all sets of base curves with sub-axes as well as the zone width that has to be predetermined in accordance with the requirement of the new shape of the cornea 12 to be molded. Then, the lens sagittal height of all 4 sets of base curves 30 with sub-axes, S_{OZ1}, S_{OZ2}, S_{OZ3}, S_{OZ4} are determined, and the values are subtracted from the corresponding corneal sagittal heights S₁, S₂, S₃, S₄, of the sub-axes aforementioned to obtain the sagittal heights of the alignment zone(s) 26, S_{az1}, S_{az2}, S_{az3}, S_{az4} and further converted into the alignment curves AZ₁, AZ₂, AZ₃, AZ₄ for forming the alignment zone 26 of the P-Qdrt ortho-k contact lens 20. It is important to match the sub-axis of the toric base curve(s) to that of the P-Qdrt alignment zone(s) 26. Herein, the toric base curve(s) 30 of the central back surface of a myopic ortho-k contact lens 20 is predetermined for molding off the internal astigmatism, while the P-Qdrt alignment zone(s) 26 is set for orientation control. The toric base curve(s) 30 of the optical zone 22 is also flatter than the central corneal curvature with a cylinder axis orthogonal or oblique to that of the central cornea. If the sub-axis of the base curves of the optical zone 22 is orthogonal to that of the alignment zone(s) 26, the sagittal height values S_{OZ1}, S_{OZ2}, S_{OZ3}, S_{OZ4} of the corresponding sets of the base curves with sub-axis can be added to or subtracted from the corresponding sets of the corneal sagittal heights S₁, S₂, S₃, S₄ directly. If the sub-axis of S_{OZ1}˜S_{OZ4} and S₁˜S₄ are oblique to each other, for example in 45° degrees to each other, the formula for figuring oblique astigmatism will be applied to match the sagittal heights of S_{OZ1}, S_{OZ2}, S_{OZ3}, S_{OZ4} to corresponding S₁, S₂, S₃, S₄ with sub-axis. The oblique astigmatism power (O) at a deviation angle X° and a toric power T (in diopters), can be estimated with the equation 2, O=T*SIN((X°)*PI( )/180)\hat{ }2. and. that of the oblique astigmatism power (P) at an angle orthogonal to the angle X° can be estimated with the equation 2, P=T*COS((X°)*PI( )/180)\hat{ }2.

The estimation is not an exact number but close enough for lens production. Having the two oblique astigmatism powers O and P for the base curves in place, we may derive the sagittal heights of the alignment zone(s) 26, S_{az1}, S_{az2}, S_{az3}, S_{az4} with sub-axis, and proceed to figure the back contour of the alignment zone(s) 26 for constructing the alignment zones 26 of the P-Qdrt ortho-k contact lens 20 with toric or quadrant base curves 30. The front peripheral curves of the front peripheral zone in a P-Qdrt rigid contact lens 20, including regular RGP, ortho-k and scleral lenses, can be designed single spherical or aspheric curve that is rotationally uniform, such that the edge thickness will be rotationally uneven (bumping) since its back surface, the alignment zone 26 and peripheral zone 28 are uneven. More preferably, the front peripheral zone of the P-Qdrt rigid contact lens 20, can be figured to follow the shape of back peripheral zones, alignment zone 26 and peripheral zone 28, for an edge thickness rotationally uniform.

For the P-Qdrt soft contact lens, the corneal sagittal height with sub-axes are derived to form an uneven lens axial thickness with a plurality of sets of sub-axes at the peripheral portion of the contact lens, more specifically the edge thickness of a P-Qdrt soft contact lens peripheral zone should be rotationally uneven. The soft contact lens material is pliable so that the uneven edge thickness can be fabricated on either the front or back surface of the contact lens. It is preferable to create the back peripheral curve of the contact lens peripheral zone unevenly, while making the front peripheral zone rotationally a single curvature. The S_{az1}, S_{az2}, S_{az3}, S_{az4}, can be figured in the same way for the P-Qdrt scleral contact lens 20 by estimating the elevation height difference with a 3D map, OCT or trial lenses, to drape the contact lens properly on the scleral portion of the eye 10. The elevation height in a sub-axis can be adjusted in 50-100 microns individually, which will be reflected in the edge thickness of a finished soft contact lens.

Converting lens sagittal height to the P-Qdrt alignment curve(s). The 4 sets of lens sagittal heights derived for the alignment zone(s) 26 of S_{az1}, S_{az2}, S_{az3}, S_{az4}, can be converted to 4 sets of back curves within sub-axis for the predetermined zone width. The curves can be 4 sets of spherical curves, 4 sets of aspheric curves, or mixing spherical and aspheric curves simply if the 4 sets of peripheral alignment curves match the derived sagittal heights S_{az1}, S_{az2}, S_{az3}, S_{az4}, respectively for the zone width and sub-axis. Using the equation 4, “Converting sagittal height to curvature”, we can convert the sagittal height value S_{az}, to an annular alignment zone 26, with an alignment curve, by equation 4, AC=SQRT(((S_{az}²+(D_{az}/2−D_{IZ}/2)²+D_{IZ}*(D_{az}/2−D_{IZ}/2))/2)²/S_{az}²+(D_{IZ}/2)²)), wherein “D_{az}” is the diameter of the alignment zone 26, and “D_{IZ}” is the diameter of the intermediate zone 24, of the contact lens 20. The sagittal height S_{az} for the alignment zone 26 can be used to derive a single annular zone with the formula aforementioned, or the zone can be divided into plurality of annular alignment zones 26 having a total sagittal height equals to S_{az}, of which the plurality of alignment zones 26 can also be fused to form an aspheric alignment zone 26, using the e-value derived by the formula of e_{az}=SQRT(R_{b}²−Rₐ²)/(Zoneₐ+Zone_{b}), wherein Rₐ and R_{b} are the radius of curvatures of the two alignment zones to be fused having zone width of Zoneₐ and Zone_{b} respectively. The aspheric alignment zone 26 such formed will have a radius of curvature Rₐ, zone width (Zoneₐ+Zone_{b}), and e-value of e_{az}. The four sets of alignment zone AC₁, AC₂, AC₃, AC₄ for each sub-axis can be converted from the sagittal height values of S_{az1}, S_{az2}, S_{az3}, and S_{az4}, utilizing the equation 4 as aforementioned.

The plurality of sets of alignment zone curves with sub-axes have to be connected for a smooth, though uneven, annular alignment curve of the back surface of the contact lens 20, which is well know to a skillful engineer for programming the lathe machine to cut the contact lenses. With the aforementioned method in place, we can derive plurality of sets of ocular sagittal height S for the zone width D, and predetermine the base curve(s) 30 of the central optical zone 22, OZ with the base curve BC for any goal without conforming the central corneal shape; and figure the sagittal height S_{IZ} of the intermediate zone 24 for the kind of the contact lenses 20. In ortho-k lenses, the S_{IZ} is not zero and is figured to design the intermediate zone 24 connecting the optical zone 22 and alignment zone 26. For a P-Qdrt RGP, P-Qdrt scleral lens and PQdrt soft contact lens, the intermediate curve 24 might be missing and the S_{IZ} is assigned zero in value.

Furthermore, we need to determine the factor K for adjusting the peripheral alignment force of the P-Qdrt contact lens exerted on the peripheral portion of the ocular surface; then obtaining the plurality of sets of lens sagittal heights with sub-axes for alignment zone 26; and converting the plurality of sets of lens sagittal height to form plurality of sets of alignment curves for a P-Qdrt rigid contact lens 20. Whereas the front peripheral curve of the front peripheral zone in a rigid contact lens 20 is preferred made to follow the back peripheral zones rotationally, such that the edge thickness shall be rotationally uniform with better comfort wearing a contact lens 20 on eye 10.

The elevation height with sub-axis of the eye 10, measured for designing alignment zones 26 of a P-Qdrt soft contact lens, can be figured into either back peripheral surface or front peripheral surface of the contact lens. If the front peripheral surface of the contact lens peripheral zone is made uneven to equalize the sagittal height difference among sub-axis or quadrants, the back surface of the alignment zone 26 should be made rotationally even; while vice versa, if making the back surface uneven, the front surface could be created rotationally even and, in both conditions, should not follow the curvatures of the opposite side. The uneven lens sagittal heights of S_{az1}, S_{az2}, S_{az3}, S_{az4} can be converted to form uneven edge thickness of the soft contact lens, such that the thicker peripheral edge fits on steeper or depressed ocular surface portion and the thinner peripheral edge fits on flatter or elevated ocular surface portion, for the lens to drape the bumping peripheral ocular surface and become a rotationally even surface while wearing the contact lens peripheral zone on eye 10.

The front and back surface of The P-Qdrt contact lens. The front and back contour of the P-Qdrt contact lenses of the present invention can be any of a conventional contact lens design, aspheric contact lens or more preferably, incorporating the dual geometric or reverse geometric designs, which has been disclosed in U.S. Pat. Nos. 6,652,095 and 7,070,275, 6,543,897, 6,997,553, 7,360,892, 8,500,273, 8,864,307, 8,950,895 for all kinds of purposes including but not limited to vision correction, corneal rehabilitation/reconstruction, myopia control or ortho-k corneal molding. We may create the P-Qdrt lens of the present invention with the formula and methodology as aforementioned, to form uneven peripheral back curves in the rigid contact lenses 20 or uneven edge thickness in the soft contact lens, for the contact lenses 20 and peripheral zone to fit more intimately on the peripheral portion of the ocular surface of eye 10 for orientation control, upright control, and peripheral alignment, which may significant improve the comfort, vision clearness, and ortho-k effect.

The P-Qdrt rigid corneal contact lens trial set. For best orientation control and peripheral alignment, ECP may have a trial set for adjusting the rotational deviation of the kind of P-Qdrt contact lenses that need orientation control for front or back toric optical zone 22 in a corneal RGP or ortho-k contact lenses 20. The trial set shall have pre-determined P-Qdrt back contour for orientation control and/or peripheral alignment that are suitable for general population, and have a drill dot or line mark at 6 o/c or any other fixed sub-axis for identification of the orientation. We may observe the rotation of the drill dot or line mark on a trial lens to estimate the angle deviated from the original setting when trial fitting on the eye 10 and adjust the astigmatism axis and/or power to grind on the front or back surface of the central portion of the contact lens 20. Although the astigmatism power and axis, added on the central portion of the front or back surface of the rigid contact lens 20, can be derived empirically by calculation, it would be more reliable to over refract the trial lens and adjust the cylinder axis for any rotation deviation on the eye 10. For the ECPs without P-Qdrt trial set, they may order a P-Qdrt corneal contact lens 20 empirically with a drill dot or line mark on front surface for identification and fine tuning the cylinder axis and/or power in warranty exchange. The trial set for testing orientation works the best if the lens matches the corneal sagittal height with sub-axis completely (100%), while partial (30%-90%) matching will be helpful in adjusting the rotation deviation to fabricate a central front or back toric contact lens 20.

The most useful range of sagittal height differences among sub-axis for a corneal rigid lens set would be between 120 to 250 microns. The bigger the lens size the higher the sagittal height differences would be required for trial sets. One of the preferred embodiments, the sagittal height difference for the 10.8 mm P-Qdrt ortho-k lens is about 150 microns between two mirror sub-axis, as 0° versus 180° or 90° versus 270°, which is a “tilt set”. There is yet another preferred embodiment for the 10.8 mm P-Qdrt corneal rigid lens set having about 150 microns sagittal height difference between two orthogonal meridians as 0°-180° versus 90°-270°, which is a “dual set”. Both sets could be marked with drill dots or line mark at 6 o/c or any sub-axis that is known to the ECP for identification of the rotation.

The following two examples of P-Qdrts corneal rigid contact lenses 20 of the present invention are for the “Dual” and “Tilt” sets respectively.

Illustration of the sagittal height of the P-Qdrt trial lens with sub-axis, referring to FIG. 3:

Dual Set 10.8 mm Corneal Contact Lens (Dual #3)

| | Sub-axis | | | | |
|---|---|---|---|---|---|
| Height (μ) | BFS | 0° | 90° | 180° | 270° |
| Sagittal height (μ) | 2007 | 1984 | 2027 | 1984 | 2027 |
| Elevation vs BFS (μ) | 0 | +23 | −54 | +23 | −54 |

Tilt Set 10.8 mm Corneal Contact Lens (Tilt #3)

| | Sub-axis | | | | |
|---|---|---|---|---|---|
| Height (μ) | BFS | 0° | 90° | 180° | 270° |
| Sagittal height (μ) | 2007 | 1984 | 2007 | 2027 | 2007 |
| Elevation vs BFS (μ) | 0 | +23 | 0 | −54 | 0 |

The P-Qdrt Scleral Lens Trial Set

The RGP lenses can be classified as corneal lenses, corneo-scleral lenses, and (full) scleral lenses by the lens size, which are 8.0˜12.5 mm; 12.5˜15.0 mm and 15.0˜25.0 mm respectively. While the lenses can also be classified by bearing areas, for those bearing all on the cornea; bearing on the cornea and the sclera; or bearing all on the sclera, respectively. We prefer the definition with the bearing area for the P-Qdrt scleral lens 20 of the present invention. Hence, if the cornea is very small and a 13 mm lens is sufficient to cover the cornea and bears only on the sclera, it is a scleral lens. The scleral lens is usually used in managing the irregular cornea condition such as keratoconus, peripheral marginal degeneration (PMD) or corneal trauma. The scleral portion is usually less irregular despite the corneas are irregular, and hence the rotationally symmetrical spherical or aspheric designs are usually acceptable for a lens size smaller than 15.0 mm. If the lens size is bigger than 15.0 mm, the scleral contour may become toric disregard whether the cornea 12 is normal or not. If the wearer has a tighter upper lid, the scleral lens may be compressed by the upper lid to bear more closely on the upper ocular surface of the eye 10 and form uneven tear layer thinner in upper portion and progressively thicker to the lower cornea edge. The uneven tear layer may in turn induce residual astigmatism, which is usually against-the-rule (ATR) and intolerable. For some of the off-centered keratoconus or PMD cases the asymmetry may extend beyond the cornea margin up to the scleral portion substantially influencing the lens centration and/or tilting, which in turn may cause oblique astigmatism. For those cases having pinguecula bumps on or beyond limbus, there is a need to design P-Qdrt lenses for loosening the peripheral zone 28 in one or two quadrants to accommodate the bumps without excessive compression. ECP may use the P-Qdrt scleral lens trial set to evaluate and demonstrate the benefits in improving lens centration, less residual or induced astigmatism, relieving conjunctiva pinching and/or vessel blenching, for the patients to feel the comfort and vision clearness while replacing a spherical-aspheric lens with a P-Qdrt lens.

The most useful range of sagittal height difference among sub-axis for a scleral lens set of 15.0˜16.0 mm would be between 50 microns and 300 microns. The bigger the lens size the higher the sagittal height difference required for a trial set. One of the preferred embodiments, the sagittal height difference for the 15.5 mm P-Qdrt scleral lens set is about 100˜120 microns at two ends of a meridian, which is a “tilt set”. There is yet another preferred embodiment for the 15.5 mm P-Qdrt scleral set having about 100˜120 microns sagittal height difference between two orthogonal meridians, which is a “dual set”. Both sets could be marked with drill dots or line mark at 6 o/c or any sub-axis that is known to the ECP for identification of the rotation deviation. It is not limited to having higher sagittal differences for the sets with bigger lens size, or forming the set by any combination of the lens sagittal heights in each sub-axis for special clinics that need such trial set for testing very irregular ocular surfaces. The beauty of using such sets is to see and evaluate the fitting in most patients and fine tune the fitting more precisely before ordering the lenses to save chair time and warranty exchange. Here illustrated are two P-Qdrts scleral contact lenses 20 of the present invention for the “Dual” and “Tilt” sets respectively.

Illustration of the sagittal height of the P-Qdrt trial lens with sub-axis, referring to FIG. 3:

Dual Set 15.5 mm Scleral Contact Lens (#F with Dual #2)

| | Sub-axis | | | | |
|---|---|---|---|---|---|
| Height (μ) | BFS | 0° | 90° | 180° | 270° |
| Sagittal height (μ) | 4480 | 4425 | 4536 | 4425 | 4536 |
| Elevation vs BFS (μ) | 0 | +55 | −54 | +55 | −54 |

Tilt Set 15.5 mm Scleral Contact Lens (#F, Tilt #2)

| | Sub-axis | | | | |
|---|---|---|---|---|---|
| Height (μ) | BFS | 0° | 90° | 180° | 270° |
| Sagittal height (μ) | 4480 | 4425 | 4480 | 4536 | 4480 |
| Elevation vs BFS (μ) | 0 | +55 | 0 | −54 | 0 |

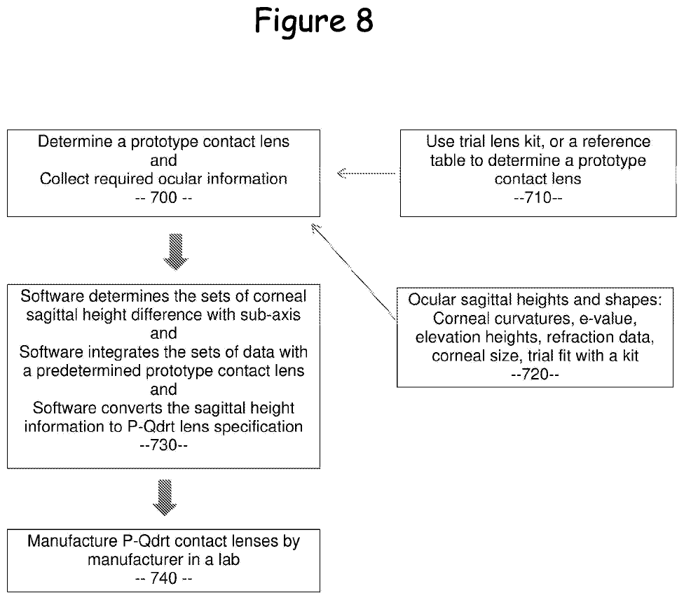

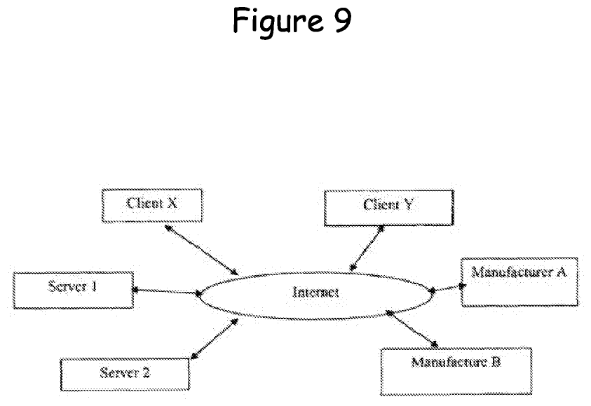

Software Tool for Calculating and Ordering Q-Qdrt Lenses. In accordance with the present invention, a computer software tool can also be implemented to help ECP (eye care practitioners) to determine and use corneal information for a plurality of sets of alignment zone curves with sub-axes for a P-Qdrt contact lens 20. The software comprises a database portion and a set of logic calculation components, as illustrated in FIG. 8 and FIG. 9.

FIG. 8 illustrates a simplified process flow in accordance with the present invention. At step 700, ocular sagittal height and sagittal height differences of sub-axes are determined utilizing the measured corneal or ocular surface information including but not limited to the corneal curvatures, e-value, elevation map, corneal size, other data in a topography or OCT, refraction data, a reference table or a trial kit (step 720). A best-fit prototype contact lens of known specification, having rotationally uniform sagittal height for BFS corneal or ocular shape is then determined (step 710). Upon determining the corneal sagittal height of sub-axes, a software tool integrates the corneal or ocular surface information, and calculates the plurality of sets of ocular sagittal height differences within sub-axes, then utilizes the obtained ocular data to modify the alignment zone sagittal height of the prototype contact lens within each sub-axis and generate the P-Qdrt lens specification (step 730). The data inputting is performed by a client processor, such as “Client X” and “Client Y” in FIG. 9, while calculating a lens specification can be performed by the client processor or by a server (“Server 1” or “Server 2” in FIG. 9) connected to the client processor through a global data communication network. The manufacturing specification is then transmitted to a predetermined manufacturing machine of a manufacturer (“Manufacturer A” or “Manufacturer B” in FIG. 9) or at the client's site in order to manufacture the P-Qdrt contact lens based on the P-Qdrt lens specification (step 740).

The present lens can be used in the treatment of ametropia or a corneal disorder, such as myopia, hyperopia, presbyopia, or astigmatism, as described herein. After designing a lens to treat the indicated condition and to center on a user's eye (as described above), the present method of treatment would comprise the application of the lens to a user's eye in order to correct myopia, hyperopia, presbyopia, astigmatism or other ametropia or corneal disorder, and/or to effect the reshaping of a cornea through orthokeratology. One skilled in the art will understand how to direct the further use of the present lens depending on the lens material (hard or soft contact lens), treatment modality (standard or ortho-k lens), and other factors.

### EXAMPLES

### Example 1

A pair of P-Qdrt ortho-k contact lenses having the following dimensions was provided for the 860908 patient:

<Right Eye>

KM: 41.49 D (8.13 mm)@0°, 44.49 D (7.59 mm) @90°

e-value: E_{f}: 0.68/Eₛ: 0.32

HVID: 12 mm

Refraction: −5.00-3.00@180 (myopia −5.00D astigmatism 3.00D axis 180)

Elevation Height by Elevation Map: (8 mm Zone)

| Elevation (μ) | 0° | 90° | 180° | 270° |
|---|---|---|---|---|
| OD | 17 | −47 | 8 | −63 |

optical zone 22: width 5.6 mm, radius of curvature 9.66 mm

intermediate zone 24_1: width 0.3 mm, radius of curvature 5.88 mm

intermediate zone 24_2: width 0.3 mm, radius of curvature 6.47 mm

alignment zone 26: width 1.8 mm,

Radius of Curvature for Best Fit Sphere (BFS) 8.06 mm

| Sub-axis | 0° | 90° | 180° | 270° |
|---|---|---|---|---|
| curve (e = 0.48) mm | 8.21 | 7.97 | 8.21 | 7.89 |

peripheral zone 28: width 0.4 mm, radius of curvature 11.30 mm

front optical zone 31 (Power surface): zone width 7.0 mm, radius of curvature 9.3 mm

Material refraction index: 1.4333

Center thickness (C.T.): 0.2 mm

Front Peripheral Zone: To Follow the Back Curves for 0.12 mm Edge Thickness.

| Sub-axis | 0° | 90° | 180° | 270° |
|---|---|---|---|---|
| curve (e = 0) mm | 8.0 | 7.84 | 8.0 | 7.79 |

Edge thickness: rotationally 0.12 mm

<Left Eye>

KM: 41.45 D (8.14 mm)@0°, 44.31 D (7.61 mm) @90°

e-value: E_{f}: 0.61/Eₛ: 0.19

HVID: 12 mm

Refraction: −4.75-3.00@180 (myopia −4.75D astigmatism 3.00D axis 180)

Elevation Height by Elevation Map: (8 mm Zone)

| Elevation (μ) | 0° | 90° | 180° | 270° |
|---|---|---|---|---|
| OS | 15 | −50 | 25 | −60 |

optical zone 22: width 5.6 mm, radius of curvature 9.60 mm

intermediate zone 24_1: width 0.3 mm, radius of curvature 5.82 mm

intermediate zone 24_2: width 0.3 mm, radius of curvature 6.41 mm

alignment zone 26: width 1.8 mm

Radius of Curvature for Best Fit Sphere (BFS) 8.06 mm

| Sub-axis | 0° | 90° | 180° | 270° |
|---|---|---|---|---|
| curve (e = 0.48) mm | 8.26 | 7.93 | 8.26 | 7.85 |

peripheral zone 28: width 0.4 mm, radius of curvature 11.30 mm

front optical zone 31 (Power surface): zone width 7.0 mm, radius of curvature 9.25 mm

Material refraction index: 1.4333

Center thickness (C.T.): 0.2 mm

Front Peripheral Zone: To Follow the Back Curves for 0.12 mm Edge Thickness.

| Sub-axis | 0° | 90° | 180° | 270° |
|---|---|---|---|---|
| curve (e = 0) mm | 8.04 | 7.83 | 8.04 | 7.78 |

Edge thickness: rotationally 0.12 mm

The patient wore the ortho-k contact lenses for 7 nights, 7-8 hours a day. After this correction period, the patient experienced myopia and astigmatism reduction to zero power with 20/20 far vision in both eyes. This is equivalent to a myopia reduction of −6.25 D and astigmatism 3 D on the right eye and myopia −6.00D and astigmatism 3 D on the left eye. The maintenance period (of nearly zero power) lasted for all awakening hours with 5-7 hours' maintenance night wearing. The topography of the cornea is well-centered and has a uniform central ablation like 4 mm treatment zone with a very steep peripheral ring to support an efficient reduction in myopia and high astigmatism. This case has been followed for over 1 year and the patient is satisfactory in vision, comfortable and no side effects.

1. A contact lens comprising:
an optical zone in a central portion of the lens having a front surface, a back surface, and a base curve, wherein the back surface of the optical zone has a curvature which is rotationally symmetrical; and
an alignment zone surrounding the optical zone and extending radially outwardly from the optical zone, the alignment zone having a front surface and a back surface,
wherein the contact lens is bisected by at least a first axis and a second axis, and wherein each axis comprises two opposed radial lines extending from the intersection of the first axis and the second axis, thereby forming:
(i) a first sub-axis having a first alignment curve and a first predetermined sagittal height in the alignment zone;
(ii) a second sub-axis having a second alignment curve and a second predetermined sagittal height in the alignment zone;
(iii) a third sub-axis having a third alignment curve and a third predetermined sagittal height in the alignment zone; and
(iv) a fourth sub-axis having a fourth alignment curve and a fourth predetermined sagittal height in the alignment zone,
wherein the predetermined sagittal height in the alignment zone of one of the sub-axes is different from the predetermined sagittal height in the alignment zone of at least one other sub-axis.

2. The contact lens of claim 1, wherein the lens further comprises an intermediate zone coupled to and extending radially outward from the optical zone.

3. The contact lens of claim 2, wherein the optical zone further comprises an inner additive optical zone in a central portion of the optical zone, and wherein the inner additive optical zone has a single set of curvatures steeper than the base curve.

4. The contact lens of claim 2 for use in myopic orthokeratology, wherein the base curve is rotationally a single curvature and has a longer radius than a measured central corneal curvature.

5. The contact lens of claim 4 for use in myopic orthokeratology with internal astigmatism, wherein the base curve is toric.

6. The contact lens of claim 2 for hyperopic orthokeratology, wherein the base curve is rotationally a single curvature and has a shorter radius than a measured central corneal curvature.

7. The contact lens of claim 3 for myopic presbyopia orthokeratology, wherein the base curve is rotationally a single curvature and has a longer radius than a measured central corneal curvature of a subject.

8. The contact lens of claim 3 for hyperopic presbyopia orthokeratology, wherein the base curve is rotationally a single curvature and has a shorter radius than a measured central corneal curvature of a subject.

9. The contact lens of claim 1, wherein the curvature of the front surface is one of a spherical, aspheric or toric curvature.

10. The contact lens of claim 1, further comprising a peripheral zone having a front surface and a back surface which is coupled to and extends radially outwardly from the alignment zone.

11. The contact lens of claim 10, wherein the back surface of the peripheral zone has a rotationally uniform curvature but is uneven in shape compared to the alignment zone.

12. The contact lens of claim 11, wherein the front surface of the peripheral zone is parallel to the uneven shape of the back surface of the peripheral zone in order to form a rotationally uniform edge thickness.

13. The contact lens of claim 11, wherein in the front surface of the peripheral zone is rotationally symmetrical in curvature, thereby forming an uneven edge thickness that is relatively thicker in one or more portions of the peripheral zone and thinner in other portions of the peripheral zone.

14. The contact lens of claim 12, wherein the lens is a rigid contact lens.

15. The contact lens of claim 13, wherein the lens is a soft contact lens.

16. The contact lens of claim 1, wherein the predetermined sagittal height in the alignment zone of three of the sub-axes are different from each other.

17. The contact lens of claim 1, wherein the predetermined sagittal height in the alignment zone of all of the sub-axes are different from each other.

18. A method of manufacturing the contact lens of claim 1 by using a computer to determine the data for use in orientation control, upright control, or peripheral alignment of the contact lens, comprising:
determining manufacturing data by inputting data representative of at least one of the following data into said computer, said computer being adapted to calculate said data:
corneal sagittal heights readings;
corneal shape factors, p-value, e-value, or q-value;
corneal curvature readings (KM);
corneal size;
specification of selected best-fit prototype contact lens;
refractive error for correction or molding; and
ocular surface information obtained by OCT, 3D map, or trial fitting set;
based on at least one of the above-inputted data, generating data by said computer;
based on predetermined processes, generating a manufacturing specification by said computer;
transmitting said manufacturing specification into a predetermined manufacturing machine;
manufacturing by said manufacturing machine for one, or a set of, contact lenses.

19. The method of claim 18, wherein inputting is performed by a client processor and calculating is performed by the client processor or by a server connected to the client processor through a global data communication network.

20. A method of treating ametropia or a corneal disorder of a subject, comprising the step of applying the contact lens of claim 1 to the eye of the subject.
